(19) United States
(12) Patent Application Publication
(10) Pub. No.: US 2024/0377667 A1
(43) Pub. Date: Nov. 14, 2024

(54) GLAZING UNIT WITH ELECTRICALLY CONTROLLABLE OPTICAL PROPERTIES WITH TEMPERATURE-DEPENDENT SWITCHING BEHAVIOR

(71) Applicant: SAINT-GOBAIN GLASS FRANCE, COURBEVOIE (FR)

(72) Inventors: Karl MALACHOWSKI, HERZOGENRATH (DE); Richard STELZER, HERZOGENRATH (DE); Adil JAAFAR, HERZOGENRATH (DE); Huixing ZHANG, HERZOGENRATH (DE)

(21) Appl. No.: 18/686,151

(22) PCT Filed: Jul. 25, 2022
(86) PCT No.: PCT/EP2022/070773

§ 371 Date: Feb. 23, 2024

(30) Foreign Application Priority Data
Aug. 24, 2021 (EP) 21192743.9

(51) Int. Cl. G02F 1/133; B32B 17/10; B60J 3/04; G02F 1/1334; G02F 1/1343

(52) U.S. Cl. CPC G02F 1/13306; B32B 17/10036; B32B 17/10174; B32B 17/10504; B32B 17/10532; B60J 3/04; G02F 1/1334; G02F 1/13439; B32B 2605/00

(57) ABSTRACT

A glazing unit with electrically controllable optical properties, includes a laminated pane with a functional element having electrically controllable optical properties, and a control unit (10) electrically connected to the functional element, wherein the control unit has a data set or a programmed function which assigns a voltage ramp to each temperature in a predefined temperature range, wherein the control unit is suitable for ascertaining the temperature, selecting a voltage ramp from the data set on the basis of the ascertained temperature or calculating it by the programmed function, and applying the electrical voltage with the selected or calculated voltage ramp to the functional element.

The invention relates to a glazing unit with electrically controllable optical properties, to the use thereof and to a method for the control thereof.

Glazing units with electrically controllable optical properties are known as such. They comprise laminated panes equipped with functional elements whose optical properties can be changed by an applied voltage. The voltage is applied via a control unit which is connected to two planar electrodes of the functional element, between which the active layer of the functional element is located. An example of such functional elements is SPD functional elements (suspended particle device), which are known, for example, from EP 0876608 B1 and WO 2011033313 A1. By applying voltage, the transmission of visible light can be controlled by SPD functional elements. Another example is PDLC functional elements (polymer-dispersed liquid crystal), which are known, for example, from DE 102008026339 A1. The active layer contains liquid crystals which are embedded in a polymer matrix. If no voltage is applied, the liquid crystals will be aligned in a unordered manner, which results in strong scattering of the light passing through the active layer. If a voltage is applied to the planar electrodes, the liquid crystals will align in a common direction and the transmission of light through the active layer is increased. The PDLC functional element operates primarily by increasing the scattering instead of by reducing the total transmission, as a result of which a clear view can be prevented or anti-glare protection can be ensured. Electrochromic functional elements are also known, for example from U.S. Pat. No. 20,120,026573 A1, WO 2010147494 A1 and EP 1862849 A1 and WO 2012007334 A1, in which a change in transmission is the result of electrochemical processes which is induced by the applied electrical voltage.

Such glazing units can be used, for example, as vehicle window panes, whose light transmission behavior can then be controlled electrically. They can be used, for example, as roof panels to reduce exposure to direct sunlight or disruptive reflections. Such roof panels are known, for example, from DE 10043141 A1 and EP 3456913 A1. Windshields have also been proposed in which an electrically controllable sun screen is realized by a switchable functional element in order to replace the conventional mechanically foldable sun screen in motor vehicles. Windshields with electrically controllable sun screens are known, for example, from DE 102013001334 A1, DE 102005049081 B3, DE 102005007427 A1 and DE 102007027296 A1.

It is also known to provide such a glazing unit or the switchable functional elements with a plurality of segments, the optical properties of which can be switched independently of one another. For example, one region of the functional element can be selectively darkened or provided with a high level of light scattering, while other regions remain transparent. Glazing units with independent segments and a method for their production are known, for example, from WO 2014072137 A1. Reference is also made to WO 2017157626 A1.

By applying an electrical voltage to the individual segments, the optical properties can be controlled. Animation schemes are thus also possible in which segments, for example, can be darkened or switched to opaque or transparent in succession, randomly in any order or from the outer segments to the inner segments. However, the optical properties of the functional element are temperature-dependent. For example, high temperatures, e.g., above 50° C., can result in the electrical resistance of the planar electrodes increasing greatly. If an electrical voltage is then applied to specific segments at high temperatures, this results in the generation of electric fields in the vicinity of actually switched-off segments. The segments then do not change their optical state due to the targeted application of a voltage but rather due to the electric field.

Another optical problem occurs when the functional element is operated under particularly low temperatures, e.g., below 0° C. In this case, the switching time of the functional element can be greatly increased. If the duration between two optical states is usually less than one second, the duration at low temperatures can be several minutes before the change from one optical state to another has been completed. As a result, the unaware user of the functional element assumes that the functional element is not working properly. One solution to this problem is disclosed in WO 2019111235 A1. By means of a heated coating which heats the functional element when temperatures are excessively low, the duration of the switching can be kept constant. However, this solution requires the use of a heated coating which has to be operated electrically. Additional space must therefore be available and a further electrical supply must be ensured. WO 9837453 A1 discloses an electrochromic element in which a temperature-dependent electrical voltage is applied to the electrochromic element in order to enable the fastest possible color change. The temperature is ascertained by means of a temperature-sensing device which preferably measures directly within the electrochromic functional element. The temperature-dependent voltage is applied to the electrochromic functional element by means of a temperature-independent and preferably linear voltage ramp in order to achieve a color change of the functional element.

There is a need for glazing units in which the switching behavior of their electrically controllable optical properties is improved. The object of the present invention is to provide such an improved glazing unit and a method for the control thereof.

The object is achieved according to the invention by a glazing unit having electrically controllable optical properties. The glazing unit comprises:
a laminated pane with a functional element having electrically controllable optical properties and
a control unit electrically connected to the functional element.

The control unit has a data set or a programmed function, which assigns a voltage ramp to each temperature in a predefined temperature range. The control unit is also suitable for
ascertaining the temperature of the functional element,
selecting a voltage ramp from the data set on the basis of the ascertained temperature or calculating it by means of the programmed function, and
applying the electrical voltage with the selected or calculated voltage ramp to the functional element.

The object is also achieved by a method for controlling a glazing unit with electrically controllable optical properties. The method is characterized in that the control unit
(a) ascertains the temperature of the functional element,
(b) selects a voltage ramp from the data set on the basis of the ascertained temperature or calculates it by means of the programmed function, and
(c) applies an electrical voltage with the selected or calculated voltage ramp to the functional element.

The glazing unit and the method are described together below, wherein explanations and preferred embodiments relate equally to glazing unit and method. If preferred features are described in connection with the method, this means that the glazing unit is preferably designed and is suitable accordingly. If, on the other hand, preferred features are described in connection with the glazing unit, this means that the method is also preferably carried out accordingly. The glazing unit is intended to be used in a vehicle or building. The laminated pane is provided for separating the interior space from the external environment during a window opening (in particular a window opening of a vehicle, but alternatively also a window opening of a building or a room).

The invention is based on the knowledge that the switching behavior of typical, electrically controllable functional elements is temperature-dependent. By ascertaining the temperature and selecting a voltage ramp from a data set or calculating a voltage ramp by means of a programmed function, the switching behavior can be adapted to the temperature. Since the time to change between two switching states is temperature-dependent, several minutes can pass depending on the temperature of the functional element before the change between two switching states has taken place, but it may also take less than one second. According to the invention, the voltage ramp with which a voltage is applied in stages to the functional element can be calculated or selected by the glazing unit as a function of the temperature of the functional element, whereby the duration for changing between two switching states can be accelerated or decelerated.

The “defined temperature range” is the temperature interval which is stored in the data set or makes up the domain of the programmed function and which must be defined before the functional element is used.

The defined temperature range preferably extends from −30° C. to 120° C., particularly preferably from −25° C. to 100° C., and in particular from −20° C. to 100° C. In these temperature ranges, the time required to change between two switching states is particularly different for the different temperatures. These temperature ranges are also common temperature ranges which occur in the natural environment (i.e., not mere laboratory conditions or exceptional conditions).

In the sense of the invention, “applying an electrical voltage” also means that a change can take place from a switching state, in which an electrical voltage is applied by the control unit, to a voltage-free switching state. The voltage-free state also describes the state of equilibrium voltage in, for example, electrochromic functional elements. Voltage-free thus rather means that no voltage is applied by a voltage source.

In a preferred embodiment of the invention, the functional element comprises at least two switching states with different optical properties and a temperature-dependent switching time is required for the change between two switching states. Consequently, a temperature with a time tₘₐₓ, which corresponds to the longest possible switching time required, exists in any arbitrary temperature range.

Wherein each voltage ramp selected or calculated on the basis of the ascertained temperature by the control unit results in a switching time t_{Switch}that is greater than or equal to tₘₐₓ, so that the switching time t_{Switch} results when an electrical voltage is applied to the functional element.

In other words, a temperature with a temperature-dependent switching speed Vₘᵢₙ, which is the lowest switching speed within the temperature range, exists in any arbitrary temperature range. The control unit has a data set or a programmed function, which assigns a voltage ramp, which results in a switching speed V_{Switch} which is less than or equal to Vₘᵢₙ, to each temperature in a predefined temperature range. In this case, the control unit
(a) ascertains the temperature of the functional element,
(b) selects the voltage ramp from the data set on the basis of the ascertained temperature or calculates it by means of the programmed function such that the switching speed V_{Switch} results when an electrical voltage is applied to the functional element, and
(c) applies the electrical voltage with the voltage ramp to the functional element so that a change takes place between the at least two switching states.

In the context of the invention, the expression “arbitrary temperature range” means that preferably for each temperature interval considered, at least one temperature exists for which the change between two switching states requires the time tₘₐₓ under otherwise constant conditions (voltage ramp, pressure, humidity, etc.). It is therefore irrelevant whether the temperatures, for example, from −20° C. to 50° C. or whether the temperatures from 0° C. to 100° C. are considered in the arbitrary temperature range. Each of these two temperature ranges has at least one temperature to which tₘₐₓ applies. “Arbitrary temperature range” also means a temperature range which extends over at least 1° C., preferably at least 2° C., in particular at least 5° C. The arbitrary temperature range thus has at least a width of 1° C. A temperature range over at least 1° C. may thus, for example, be from 150° C. to 151° C. or, for example, from −50° C. to −51° C. It is not exclusively the range from 0° C. to 1° C.

“Temperatures” (“temperature values”) may also mean non-integer numbers. Preferably, temperatures (temperature values) within a temperature range can be real numbers with up to 10 decimal places, particularly preferably up to 5 decimal places, in particular up to 2 decimal places.

As a function of the temperature of the functional element, the required switching time between two switching states can be from less than one second up to several minutes. This variable switching behavior is undesirable for a user of a glazing unit with such a functional element. With this temperature-dependent switching time of the functional element, the non-specialist user quickly receives the impression that the glazing unit is not working properly. This impression can worsen the user experience. This problem can be solved in that the control unit has a data set or a programmed function and the temperature is ascertained by the control unit. The data set assigns a voltage ramp to each temperature in a predefined temperature range. The programmed function comprises a domain, which is represented at least by the defined temperature range, and calculates a voltage ramp (voltage ramp in the codomain) by means of the temperature. If a change between two switching states is now to take place, the electrical voltage required for switching is applied with a voltage ramp selected from the data set or calculated by means of the programmed function. The voltage ramp is selected according to the ascertained temperature such that the change between the two switching states takes place at the switching speed V_{Switch}. It goes without saying that the duration for changing from the one switching state to the other switching state of the two switching states corresponds to the duration tₘₐₓ or a longer duration. The time for changing between two switching states is thus artificially extended for at least most switching operations, i.e., all switching operations having a technically necessary switching time of less than tₘₐₓ.

In the context of the invention, electrically controllable optical properties are understood, in particular, to mean such properties which are continuously controllable. In the context of the invention, “switching states between which the functional element can change” refers to the switching states which can be on a scale from a switching state with the minimum change in the optical properties (switching state 0% or minimum switching state) to a switching state of the maximum change in the optical properties (switching state 100% or maximum switching state). Between the two aforementioned states, all switching states can be continuously realized by selecting the voltage accordingly. A switching state of 20% corresponds, for example, to a change in the optical properties by 20% of the maximum change. Said optical properties relate in particular to the light transmission and/or the scattering behavior. The switching time for changing between the switching states may depend on the percentage change in the optical properties. The difference of the change is preferably directly proportional to the switching time so that, for example, a change from the switching state of 0% to a switching state of 80% preferably takes four times as long as a change of the switching state from 0% to a switching state of 20%. However, the switching time for changing between the switching states may also be independent of the percentage change in the optical properties.

In principle, however, it is also conceivable that the electrically controllable optical properties can only be switched between two discrete switching states. In that case, only two switching states exist—namely 0% and 100%. It is also conceivable that the electrically controllable optical properties can be switched between more than two discrete switching states.

An AC voltage or a DC voltage can be applied to the functional element. If the functional element is a PDLC functional element or an SPD functional element, an AC voltage is applied to the functional element. If the functional element is an electrochromic functional element, a DC voltage is applied to the functional element.

If the functional element is an electrochromic functional element, the “voltage ramp” in the context of the invention means the linear voltage change over time with a unit V s⁻¹.

If, however, the functional element is a PDLC or an SPD functional element, the voltage ramp will not be linear and is ascertained by means of an inverse function which results from the desired optical properties of the switching state. Since a non-linear coherence exists between the electrical voltage, i.e., the RMS value of the AC voltage, and the optical properties of the functional element, an inverse function is used to determine the voltage ramp. The inverse function can in particular be the inverse function of the characteristic of the setting of the switching state of the functional element. In other words, in order to reach a specific switching state, the voltage (the RMS value of the AC voltage) is applied in stages to the functional element, wherein the voltage is either reduced or increased with each stage as a function of the type of the functional element and of whether a transparent switching state or a switching state of lower transparency is to be achieved. The stagewise increase of the voltage preferably takes place non-linearly by means of the inverse function. The inverse function is temperature-dependent so that if the voltage ramp is non-linear, the voltage ramp will preferably be part of the programmed function. Alternatively, all voltage values which are applied in stages up to the final voltage are stored in the data set for all temperatures within a defined temperature range. Each voltage value change takes place within a specific period of preferably at most one second.

The programmed function includes the voltage ramp as a function of the temperature, of the current switching state and of the desired switching state. The required voltage ramp for V_{Switch} or t_{Switch} can thus be ascertained by the control unit as a function of the ascertained temperature (for example, 60° C.) and can be applied to the functional element.

In the data set, a voltage ramp value will preferably be assigned to each temperature value if the voltage ramp is linear. The data set can be created, for example, in that individual points are known by measurements and interpolation (for example, linear interpolation) is carried out between them. In principle, however, it is also possible for the data set to be present in a table-like manner, wherein a respective voltage ramp is assigned to specific temperature zones (for example, 1° C. to 2° C.) or discrete temperature values (for example, exactly 1.0° C.). The latter is less preferred since it is much more complex to ascertain measured values for all temperatures.

The temperature-dependent switching time can be longer if a switch takes place from a switching state with a higher transparency or light transmittance to a switching state with a lower transparency or light transmittance (falling switching state) than if a switch takes place from a switching state with a lower transparency or light transmittance to a switching state with a higher transparency or light transmittance (rising switching state). This means that, for example, the switching of a switching state with 40% transparency to a switching state with 70% transparency requires a shorter switching time than the switching in the reverse direction. The switching time can thus depend on the direction of the desired switching states. The voltage ramp is therefore preferably selected in each case such that, when an electrical voltage is applied to the functional element, the switching time t_{Switch} results for both the change to a falling switching state and the change to a rising switching state. The data set thus preferably has different voltage ramps assigned to each temperature within a predefined temperature range. If the control unit has a programmed function, the programmed function preferably comprises a function for the change to a rising switching state and a function for the change to a falling switching state.

Typically, the temperature-dependent, necessary switching time tₘₐₓ is significantly extended at temperatures of less than 10° C. in comparison to the switching time at temperatures of more than 10° C. In common functional elements, the limit temperature is typically about 10° C. Temperatures that are lower than 10° C. occur in particular seasonally and for weather-related reasons. The time tₘₐₓ at temperatures of 20° C. is typically 0.5 s or less. In contrast, at temperatures of −10° C., the time tₘₐₓ is typically 5 s or more. This time difference for different temperatures can increase with decreasing temperature and depending on the functional element. Preferably, the at least two switching states therefore have a longer time required to change between two switching states at lower temperatures than at higher temperatures.

Preferably, the functional element is divided into at least two separate segments, and each segment is electrically connected to the control unit so that the electrical voltage with the voltage ramp can be applied for each segment independently of one another. The functional element can also be divided into more than two separate segments. The functional element is particularly preferably divided into 3 or more separate segments, very particularly preferably into 5 or more and in particular into 10 or more separate segments. The division into different segments enables the functional element to be controlled in line with demand. By means of the independently controllable segments, the user can define which regions of the glazing unit are to be transparent and which are to be darkened, opaque or provided with high light scattering (translucency). If the glazing unit is used, for example, as a roof pane in a vehicle, excessive heating of the vehicle interior can be avoided depending on the position of the sun by selectively controlling the individual segments. It is also possible for each vehicle occupant, i.e., for example, the driver, the front-seat passenger, the passenger in the left-hand back seat and the passenger in the right-hand back seat, to be assigned a respective segment located above them.

In a particular embodiment of the invention, the functional element is controlled with an animation scheme, wherein the electrical voltage is first applied to a first segment of the at least two separate segments and, only after the switching time t_{Switch}, is the electrical voltage likewise applied to a further segment of the at least two separate segments. The further segment thus changes only after the switching operation of the first segment to another switching state has been completed. An electrical voltage is preferably applied to the further segment immediately after the previous switching operation has been completed. In this context, “immediately” means preferably a time of 1 s or less, particularly preferably 0.5 s or less, and in particular 0.1 s or less. In this case, the at least two separate segments preferably change to the same switching state. Other animation schemes are also possible. If the functional element is divided into more than two segments, segments adjoining one another can be switched in succession in the manner described above, wherein “switching” means the change from one switching state to another switching state. However, it is also possible to switch first outer segments and then successively adjoining inner segments. Naturally the reverse order is also possible.

In a further, preferred embodiment of the invention, the functional element is used with another animation scheme, wherein a voltage is simultaneously applied to all segments of the at least two segments so that all segments of the at least two segments change simultaneously to a desired switching state. Alternatively, an electrical voltage for changing the switching state is applied successively to all segments of the at least two segments with a minor time offset, preferably at most 5 seconds and particularly preferably at most 1 second.

The control unit is provided and suitable for controlling the optical properties of the functional element. The control unit is electrically conductively connected on the one hand to the functional element or optionally to the individual segments of the functional element and, on the other hand, to a voltage source. The control unit contains the electrical and/or electronic components required for applying the required voltage to the planar electrodes as a function of a switching state. The switching state can be predefined by the user (for example by operating a switch, a button or a rotary or sliding controller), can be determined by sensors and/or can be transmitted via a digital interface from the central control device of the vehicle (if the laminated pane is a vehicle window pane, usually LIN bus or CAN bus). The switches, buttons, rotary or sliding controllers can be integrated, for example, in the dashboard of the vehicle if the laminated pane is a vehicle window pane. However, touch sensors can also be integrated directly into the laminated pane, for example capacitive or resistive sensors. Alternatively, the functional element can also be controlled by contactless methods, for example by recognizing gestures, or as a function of the state of pupil or eyelid determined by a camera and suitable evaluation electronics. The control unit may, for example, comprise electronic processors, voltage converters, transistors, capacitors, diodes, and other components.

The voltage applied to the functional element is an AC voltage if the functional element is an SPD functional element or a PDLC functional element. If the functional element is an electrochromic functional element, a DC voltage is applied to the functional element.

There may be cases in which the functional element is a PDLC functional element or SPD functional element, but the voltage source is a DC voltage source. This situation occurs, for example, in a vehicle if the laminated pane is a vehicle pane and is connected to the on-board voltage. The control unit is preferably connected to the on-board electrical system, from where it obtains the electrical voltage and optionally the information about the switching state to be set. The control unit is then equipped with at least one inverter in order to convert the DC voltage into AC voltage. In a first embodiment, the control unit has a single inverter, which optionally has an output pole of the inverter with a plurality of independent outputs for separately actuating the segments of the functional element, wherein each segment is connected to one of the outputs. Each segment or the functional element as a whole is thus assigned to an output of the inverter and thereby electrically connected. The individual outputs are typically realized by switches, wherein the inverter generates a voltage which is subsequently switched. These switches can be integrated directly in the inverter. Alternatively, however, it is also possible for the inverter itself to have, strictly speaking, only a single output to which external switches are then connected in order to distribute the voltage to the segments of the functional element. In the sense of the invention, such externally connected switches are also regarded as outputs of the inverter. In a second embodiment and in the case in which the functional element has at least two segments, the control unit comprises a plurality of inverters, wherein, for the separate actuation of the segments, each segment is connected to a separate inverter. Each segment is thus electrically connected to an inverter. The first embodiment has the advantage that it is more cost-effective and more space-saving. However, it has the disadvantage that, if the functional element is divided into at least two segments, the segments can only be optically controlled digitally as it were. The segments cannot be provided with different finite switching states (be independently “dimmable” as it were), which is possible without problems in the second embodiment.

The inverter(s) can be operated in such a way that a real AC voltage is generated, including the negative components thereof with respect to the supply voltage of the control device. Since, in the case of a DC voltage source, such as in the case of a vehicle, no negative potentials are however available, this solution is technically comparatively complex. Alternatively, it is possible and frequently preferred to simulate the AC voltage as it were. The control unit is in this case equipped with two inverters, wherein the functional element is electrically connected to both inverters. The potentials of the inverters are modulated with a variable function, e.g., a sine function, wherein the potentials of a first inverter are in phase and the potential of a second inverter is phase-shifted, in particular with a phase shift of 180°. The signal of the first inverter is then inverted with respect to the signal of the second inverter. A temporally variable, periodic potential difference is thus generated with alternating relatively positive and relatively negative contributions, which corresponds to an AC voltage. If the functional element is divided into at least two segments, each segment is electrically connected to two different inverters in order to be able to modulate an AC voltage for each segment. “Different inverters” does not mean that the respective inverters cannot also be connected to a plurality of segments.

The on-board voltage of vehicles (for example, 12 to 14 V) is typically not sufficient to fully optically control the functional element. For this reason, irrespective of whether the functional element is a PDLC functional element, an SPD functional element or an electrochromic functional element, the control unit is furthermore preferably equipped with a DC-DC converter which is suitable for increasing the supplied feed voltage (primary voltage), i.e., converting it into a higher secondary voltage (for example, 65 V). The control unit is connected to the DC voltage source and is supplied with a primary voltage by the latter. The DC-DC converter converts the primary voltage into the higher secondary voltage. The secondary voltage in an advantageous embodiment is 5 V to 70 V, the AC voltage is 5 V to 50 V. If the functional element is not an electrochromic functional element, the secondary voltage is converted by an inverter into an AC voltage (for example, 48 V).

According to the invention, the temperature of the functional element is ascertained in order to select or calculate, on the basis of this temperature, the voltage ramp with which an electrical voltage is applied. It is assumed here that the laminated pane has a homogeneous temperature overall, i.e., the temperature of the functional element matches the temperature of other regions of the laminated pane, which is typically at least approximately the case. Ascertaining the temperature of the laminated pane accordingly corresponds at least approximately to ascertaining the temperature of the functional element.

In an advantageous embodiment, the laminated pane is equipped with a temperature sensor. The temperature sensor is connected to the control unit in such a way that the control unit can ascertain the temperature of the laminated pane and thus of the functional element by means of the temperature sensor. The measurement signal of the temperature sensor is thus transmitted to the control unit and evaluated there so that the control unit ascertains the temperature of the laminated pane by means of the temperature sensor. The temperature sensor can be integrated in the laminated pane. Alternatively, the temperature sensor can be fastened externally to the laminated pane or assigned thereto. Preferably, the temperature sensor is fastened to a surface of the laminated pane facing the interior (for example, the vehicle interior). The temperature sensor can also be arranged in the control unit itself or in a fastening element with which the control unit is fastened to the laminated pane. In principle, it is also possible to use a temperature sensor which is neither fastened directly to the laminated pane nor integrated therein but measures the temperature at a distance, e.g., an IR sensor which is arranged in the vicinity of the laminated pane and is directed to the latter.

In a further advantageous embodiment, the control unit is suitable for ascertaining the electrical impedance of the functional element and for ascertaining the temperature of the functional element therefrom. This is possible since the impedance (the equivalent of the traditional ohmic resistance in the case of AC voltages) is temperature-dependent. In particular, an injective relationship exists between the real part of the electrical impedance and the temperature of the functional element. In this way, a temperature can be assigned to each impedance. In particular, the real part of the impedance as a function of the temperature is strictly monotonically decreasing with increasing temperature. The embodiment has the advantage that it is possible to dispense with a temperature sensor which has to be integrated as a further component and therefore complicates the structure and increases the production costs. The method is performed in such a way that the control unit ascertains the impedance of the functional element and ascertains or estimates the temperature therefrom. For this purpose, a voltage is in particular applied and the resulting current flow is ascertained. The impedance can be calculated as quotient of the voltage and the current flow. Impedance data, e.g., an impedance curve or impedance table, which describe the temperature dependence of the impedance (more precisely, of the real part of the impedance) (impedance as a function of the temperature or temperature as a function of the impedance) are stored in the control unit. By comparing the magnitude of the measured impedance to the impedance data, the control unit can approximately ascertain the temperature.

For ascertaining the impedance, various embodiments are in turn possible, in particular with regard to the measurement of the power consumption. If the control unit comprises at least one inverter, which converts an incoming DC voltage into an outgoing AC voltage, so that the output current of the inverter is measured. The problem here is that the current ascertained in this way (“apparent current” or also “total current”) is composed of two components, namely the reactive current (figuratively speaking, caused by the “pushing back and forth” of electrons as a result of the AC voltage and the capacitively acting functional element) and the active current (caused by parasitic losses in the supply lines and in the functional element). However, only the active current is decisive for ascertaining the impedance (more precisely, its real part). The active component of the measured current (active current) then has to be calculated from the total current by the control unit, for example by ascertaining the phase shift between voltage and apparent current.

If the functional element is a PDLC functional element or an SPD functional element, the impedance in a particularly preferred variant can be ascertained from a measurement of the current consumption of the inverter. The control unit is suitable for this ascertainment. Since only DC voltages are present here, any reactive current disappears on average over time, provided that it has not been absorbed by the intermediate circuit capacitors in the inverter anyway. Taking into account a loss factor in the inverter, the measured current can be used accordingly directly as a basis for ascertaining the impedance. A further advantage is that this current measurement is frequently present anyway for fault detection (short circuit and overload) and additional component costs can be dispensed with.

As a further possibility for ascertaining the temperature of the functional element, an estimation algorithm can be used. The estimation algorithm is preferably located in the control unit and is executed there. The temperature of the functional element is estimated on the basis of one or more measured signals. The signals for temperature estimation can be measurement data, preferably concerning the internal temperature, the external temperature, thermal radiation (infrared rays, secondary heat and/or ultraviolet rays) and/or the travel speed if the laminated pane is used as a vehicle pane in a vehicle. The signals can be measured via sensors, typically located in vehicles anyway, and transmitted to the control unit. Alternatively, sensors can also be arranged in the vicinity of the laminated pane specifically for the purpose of temperature estimation. In any case, the sensors are connected to the control unit. By means of the estimation algorithm, the temperature can be estimated on the basis of the measured signals. The temperature is a function of one or more signals; the signals are thus the domain and the temperature is the codomain. The temperature of the functional element can be ascertained by means of the estimation algorithm irrespective of whether the functional element is a PDLC functional element, SPD functional element or electrochromic functional element.

In a preferred embodiment, the functional element is a PDLC (polymer-dispersed liquid crystal) functional element. The PDLC functional element contains liquid crystals, which are embedded in a polymer matrix. If no voltage is applied to the PDLC functional element, the liquid crystals are aligned in an unordered manner, which results in strong scattering of the light passing through the active layer (translucency). If a voltage is applied to the functional element, the liquid crystals align in a common direction and the transmission of light through the functional element is increased (transparency). However, it may also be the case that the liquid crystals are present ordered in a voltage-free state and the liquid crystals are accordingly present unordered if a voltage is applied. However, other functional elements can also be used, the variability of whose optical properties is based on liquid crystals, for example PNLC (polymer-networked liquid crystal) functional elements. When the application of a voltage is mentioned in connection with the functional element as PDLC functional element, an AC voltage (the RMS value of the AC voltage, not the instantaneous voltage) in the sense of the invention is always meant.

In a further preferred embodiment, the functional element is an SPD (suspended-particle device) functional element. In this case, the SPD functional element contains suspended particles. The suspended particles change the optical state of the functional element by absorbing light as a result of application of a voltage. SPD functional elements thus have switching states with transparent and opaque optical properties and intermediate stages between transparency and opacity. When the application of a voltage is mentioned in connection with the functional element as SPD functional element, an AC voltage (the RMS value of the AC voltage, not the instantaneous voltage) in the sense of the invention is always meant.

In a further, preferred embodiment, the functional element is an electrochromic functional element. In this case, the transmission of visible light through the functional element depends on the degree of embedding of ions. The ions are released, for example, by an ion storage layer and embedded in an electrochromic layer. The transmission can be influenced by the voltage which is applied to the functional element and causes a migration of the ions. Suitable electrochromic layers contain, for example, at least tungsten oxide or vanadium oxide. If the functional element is an electrochromic functional element, the control unit will preferably not be equipped with an inverter and a DC voltage is applied to the functional element. A DC-DC converter for reaching voltages in the range of 1 V to 50 V and preferably 10 V to 42 V can, however, be a component of the control unit depending on need.

In a further, preferred embodiment, the functional element is an SPD functional element or a PDLC functional element. The switching speed of the functional element can be influenced significantly better with the voltage ramp when the functional element is operated by means of an AC voltage. In particular, the functional element is a PDLC functional element. It has been shown in experimental studies that the technical effect of the invention deploys particularly advantageously for PDLC functional elements.

The aforementioned controllable functional elements and their mode of operation are known per se to the person skilled in the art so that a detailed description can be dispensed with at this point.

The laminated pane preferably comprises at least one outer pane and one inner pane, which are connected to one another via a thermoplastic intermediate layer.

In the context of the invention, “inner pane” refers to the pane facing the interior. “Outer pane” refers to the pane facing the external environment. The outer pane and the inner pane each have an outer and an interior-side surface and a circumferential side edge surface extending between them. In the context of the invention, “the outer surface of the inner pane and of the outer pane” refers to the main surface provided to face the external environment in the installed position. In the context of the invention, “the interior surface of the inner pane and of the outer pane” refers to the main surface provided to face the interior in the installed position. The interior surface of the outer pane and the outer surface of the inner pane thus face one another and are connected to one another by the thermoplastic intermediate layer.

The thermoplastic intermediate layer serves to connect the inner pane and the outer pane, as is common practice with laminated panes. Thermoplastic films are typically used, and the intermediate layer is formed therefrom. In a preferred embodiment, the intermediate layer is formed at least from a first thermoplastic layer and a second thermoplastic layer, between which the functional element is arranged. The functional element is then connected to the outer pane via a region of the first thermoplastic layer and to the inner pane via a region of the second thermoplastic layer. The thermoplastic layers preferably project circumferentially beyond the functional element. Where the thermoplastic layers have direct contact with one another and are not separated from one another by the functional element, they can merge together during lamination in such a way that the original layers may no longer be discernible and instead a homogeneous intermediate layer is present.

A thermoplastic layer can be formed, for example, by a single thermoplastic film. A thermoplastic layer can also be formed from sections of different thermoplastic films, the side edges of which are attached to one another.

In a preferred embodiment, the functional element, more precisely the side edges of the functional element, is surrounded circumferentially by a third thermoplastic layer. The third thermoplastic layer is frame-like with a recess into which the functional element is inserted. The third thermoplastic layer can be formed by a thermoplastic film into which the recess has been introduced by cutting. Alternatively, the third thermoplastic layer can also be composed of a plurality of film sections around the functional element. The intermediate layer is then formed from a total of at least three thermoplastic layers arranged flat on top of each other, wherein the middle layer has a recess in which the functional element is arranged. During production, the third thermoplastic layer is arranged between the first and the second thermoplastic layer, wherein the side edges of all the thermoplastic layers are preferably congruent. The third thermoplastic layer preferably has about the same thickness as the functional element. This compensates for the local thickness difference which is introduced by the locally limited functional element, so that glass breakage during lamination can be avoided and an improved visual appearance result.

The layers of the intermediate layer are preferably formed from the same material, but can in principle also be formed from different materials. The layers or films of the intermediate layer are preferably based on polyvinyl butyral (PVB), ethylene vinyl acetate (EVA), or polyurethane (PU). This means that the layer or film predominantly contains the said material (more than 50% by weight) and can, in addition, optionally contain further constituents, for example plasticizers, stabilizers, UV or IR absorbers. The thickness of each thermoplastic layer is preferably from 0.2 mm to 2 mm, particularly preferably from 0.3 mm to 1 mm. For example, films with standard thicknesses of 0.38 mm or 0.76 mm can be used.

The outer pane and the inner pane are preferably made of glass, particularly preferably of soda lime glass, as is customary for window panes. However, the panes can also be manufactured from other types of glass, e.g., quartz glass, borosilicate glass or aluminosilicate glass, or from rigid clear plastics, e.g., polycarbonate or polymethyl methacrylate. The panes can be clear or tinted or colored. Depending on the application, limits can be set to the degree of tinting or coloration: for example, a prescribed light transmission must sometimes be ensured, for example a light transmission of at least 70% in the main vision area A according to Regulation no. 43 of the Economic Commission for Europe of the United Nations (UN/ECE) (ECE-R43, “Uniform provisions concerning the approval of safety glazing materials and their installation on vehicles”).

The outer pane, the inner pane and/or the intermediate layer can have suitable coatings known per se, for example anti-reflective coatings, non-stick coatings, anti-scratch coatings, photocatalytic coatings, UV-absorbing or reflective coatings or IR-absorbing or reflecting coatings such as sun protection coatings or low-E coatings.

The thickness of the outer pane and of the inner pane can vary widely and thus be adapted to the requirements in the individual case. The outer pane and the inner pane preferably have thicknesses of 0.5 mm to 5 mm, particularly preferably of 1 mm to 3 mm.

The laminated pane can be equipped with an opaque cover printing, in particular in a peripheral edge region, as is common practice in the vehicle sector, in particular for windshields, rear windows and roof panes. The cover printing is typically made of an enamel containing glass frits and a pigment, in particular black pigment. The printing ink is typically applied in a screen printing method and is then burned in. Such a cover printing is applied to at least one of the pane surfaces, preferably the interior-side surface of the outer pane and/or inner pane. The cover printing preferably surrounds a central see-through area in a frame-like manner and serves in particular to protect the adhesive, by which the laminated pane is connected to the vehicle body, against UV radiation. If the control unit is attached to the interior-side surface of the inner pane, it will preferably be attached in the opaque region of the cover printing.

The laminated pane according to the invention contains the functional element with electrically controllable optical properties, which is preferably arranged between the outer pane and the inner pane, i.e., is embedded in the intermediate layer. The functional element is particularly preferably arranged between at least two layers of thermoplastic material of the intermediate layer, wherein it is connected to the outer pane by the first layer and to the inner pane by the second layer. Alternatively, however, the functional element can also be arranged directly on the surface of the outer pane or the inner pane facing the intermediate layer. Preferably, the side edge of the functional element is completely surrounded by the intermediate layer, so that the functional element does not extend all the way to the side edge of the laminated pane and therefore has no contact with the surrounding atmosphere.

If the temperature sensor is integrated in the laminated pane, in the sense of the invention this means that the temperature sensor is laminated between the outer pane and the inner pane. The temperature sensor is preferably embedded in the intermediate layer and is particularly preferably arranged between at least two layers of thermoplastic material of the intermediate layer. Preferably, the temperature sensor is arranged adjoining the functional element so that the temperature sensor is at a distance from the functional element of 2 cm or less, particularly preferably 1 cm or less.

In a particularly preferred embodiment, the functional element comprises at least one active layer and a first and a second planar electrode which are arranged on both sides of the active layer so that the active layer is arranged between the first and the second planar electrodes. The planar electrodes and the active layer are typically arranged essentially parallel to the surfaces of the outer pane and the inner pane. The active layer has the variable optical properties which can be controlled by the electrical voltage applied to the active layer via the planar electrodes. The active layer thus preferably comprises at least the liquid crystals in a polymer matrix in the case of the PDLC functional element, at least the suspended particles in the case of the SPD functional element and at least the ion storage layer and the electrochromic layer in the case of the electrochromic functional element.

The first planar electrode preferably has at least two electrode segments which are separated from one another by an isolation line. The term “isolation line” is understood to mean a line-like region in which the material of the planar electrode is not present so that the adjoining segments are materially separated from one another and are therefore electrically isolated from one another. This means that there is no direct electrical connection between the electrode segments, but the electrode segments can be connected to one another indirectly to a certain extent in an electrically conductive manner via the active layer in contact with them. The first planar electrode can be subdivided into several segments by several isolation lines. Each electrode segment represents a segment of the functional element. The number of electrode segments can be freely selected according to the desired number of segments of the functional element. In a preferred embodiment, the isolation lines run substantially parallel to one another and extend from a side edge of the planar electrode to the opposite side edge. However, any other geometric shapes are also conceivable. The use of isolation lines for forming electrode segments of the functional element is a cost-effective and simple method for producing segments of the functional element. The second planar electrode and the active layer preferably each form a coherent, complete layer.

The isolation lines have, for example, a width of 5 μm to 500 μm, in particular 20 μm to 200 μm. They are preferably introduced into the planar electrode by means of laser radiation. The width of the segments, i.e., the distance between adjacent isolation lines, can be suitably selected by the person skilled in the art according to the requirements in individual cases.

In a particularly preferred embodiment, the second planar electrode has isolation lines extending parallel to the first planar electrode, so that both the first and the second planar electrode have at least two electrode segments which are arranged congruently in a view through the laminated pane. As a result of this arrangement, so-called crosstalk effects between the segments of the functional element can be prevented. Crosstalk effects describe a change in the switching state of segments that should actually be voltage-free but change their switching state due to adjacent segments to which a voltage has been applied. In principle, however, it is also conceivable that the second planar electrode is segmented to a lesser extent than the first planar electrode, i.e., has fewer isolation lines and electrode segments, so that a plurality of electrode segments of the first planar electrode are assigned to at least one electrode segment of the second planar electrode. In this way, costs can be saved.

The electrode segments of the first planar electrode are electrically connected to the control unit independently of one another so that a first electrical potential (which is variable over time in the case of an AC voltage) can be applied to each electrode segment (independently of the other electrode segments). The second planar electrode is likewise electrically connected to the control unit so that overall a second electrical potential can be applied to the second planar electrode. The electrical voltage with the voltage ramp is thus applied between each electrode segment and the second planar electrode. If the second planar electrode is likewise divided into electrode segments, each electrode segment of the second planar electrode is likewise electrically connected to the control unit independently of one another. If the first and the second potentials are identical, no voltage is applied between the electrodes in the respective segment (switching state of 0%). If the first and the second potential are different, a voltage is applied between the electrodes in the respective segment, whereby a finite switching state is produced. For electrochromic functional elements, an equilibrium voltage can also arise in a switching state of 0% so that the first potential and second potential are not identical. However, since almost no electrical current flows with this equilibrium voltage, the switching state only changes when a voltage from a voltage source is applied.

The planar electrodes are preferably transparent, which in the context of the invention means that they have a light transmittance in the visible spectral range of at least 50%, preferably at least 70%, particularly preferably at least 80%. The planar electrodes preferably contain at least one metal, one metal alloy or one transparent conductive oxide (TCO). The planar electrodes can be formed, for example, on the basis of silver, gold, copper, nickel, chromium, tungsten, indium tin oxide (ITO), gallium-doped or aluminum-doped zinc oxide and/or fluorine-doped or antimony-doped tin oxide, preferably on the basis of silver or ITO. The planar electrodes preferably have a thickness of 10 nm to 2 μm, particularly preferably of 20 nm to 1 μm, very particularly preferably of 30 nm to 500 nm.

In an advantageous embodiment, the functional element comprises two carrier films in addition to the active layer and the first and second planar electrodes, wherein the active layer and the planar electrodes are preferably arranged between the carrier films. The carrier films are preferably formed of thermoplastic material, for example on the basis of polyethylene terephthalate (PET), polypropylene, polyvinyl chloride, fluorinated ethylene propylene, polyvinyl fluoride or ethylene tetrafluoroethylene, particularly preferably on the basis of PET. The thickness of the carrier films is preferably from 10 μm to 200 μm. Such functional elements can advantageously be provided as multilayer films, in particular purchased commercially, cut to the desired size and shape and then laminated into the laminated pane, preferably via in each case a thermoplastic layer with the outer pane and the inner pane. It is possible to segment the first and/or the second planar electrode by laser radiation even when it is embedded in such a multilayer film. A thin, visually inconspicuous isolation line can be produced by the laser treatment without damaging the carrier film typically lying above it.

A peripheral side edge of the functional element can partially or completely be sealed, for example by melting the carrier layers or by a (preferably polymeric) tape. The optionally present, active layer can thus be protected, in particular from components of the intermediate layer (in particular plasticizers) diffusing into the functional element, which can lead to degradation of the functional element.

For electrical contacting of the functional element, or of the segments, the functional element is preferably connected to so-called flat or foil conductors, which extend out of the intermediate layer beyond the side edge of the laminated pane. Flat conductors have a band-like metallic layer as their conductive core, which layer—except for the contact surfaces—is typically surrounded by a polymeric insulation sheath. Optionally, so-called bus bars, for example strips of an electrically conductive foil (for example copper foil) or electrically conductive printings, can be arranged on the planar electrodes, wherein the flat or foil conductors are connected to the said bus bars. The flat or foil conductors are connected to the control unit either directly or via further conductors.

In an advantageous embodiment, the control unit is fastened to the interior surface of the laminated pane, preferably to the surface of the inner pane facing away from the intermediate layer. The control unit may, for example, be glued directly onto the surface of the laminated pane. In an advantageous embodiment, the control unit is inserted into a fastening element, which in turn is fastened to the interior surface of the laminated pane, preferably via a layer of adhesive. Such fastening elements are also known as brackets in the vehicle sector and are typically made of plastic. Electrical connection of the laminated pane is facilitated by attaching the control unit directly to the laminated pane. In particular, no long cables are required between the control unit and the functional element.

Alternatively, however, it is also possible for the control unit not to be fastened to the laminated pane but, for example, be integrated in the electrical system of the vehicle or be fastened to the vehicle body if the laminated pane is a vehicle pane. The control unit is preferably arranged in the interior of the vehicle such that it is not visible, for example in the dashboard or behind a paneling.

The invention also extends to a computer program product which is installed in the control unit of the glazing unit according to the invention and is suitable for
instructing the control unit to ascertain the temperature of the functional element, wherein the control unit subsequently ascertains the temperature of the functional element,
selecting a voltage ramp from the data set on the basis of the ascertained temperature or calculating it by means of the programmed function, and
instructing the control unit to apply an electrical voltage with the voltage ramp to the functional element, wherein the control unit subsequently applies an electrical voltage with the voltage ramp to the functional element.

The invention also extends to a method for controlling a glazing unit with electrically controllable optical properties, in which a glazing unit according to the invention is provided, wherein
(a) the control unit is instructed by a computer program product to ascertain the temperature of the functional element and to subsequently ascertain the temperature,
(b) the computer program product selects a voltage ramp from the data set on the basis of the ascertained temperature or calculates it by means of the programmed function, and
(c) the control unit is instructed by the computer program product to apply an electrical voltage with the voltage ramp to the functional element and subsequently applies the voltage with the voltage ramp.

The invention also relates to the use of a glazing unit according to the invention, in particular of the laminated pane of a glazing unit according to the invention, in buildings or in means of transportation on land, in the air or in water, preferably as a window pane of a vehicle, in particular of a motor vehicle. The glazing unit or the laminated pane can be used, for example, as a windshield, roof pane, rear wall pane or side pane.

In a particularly preferred embodiment, the glazing unit or the laminated pane is a windshield of a vehicle. The functional element is preferably used then as an electrically controllable sun screen, which is arranged in an upper region of the windshield, while the majority of the windshield is not provided with the functional element. The optionally present segments are preferably arranged substantially parallel to the upper edge of the windshield with increasing distance therefrom. As a result of the independently controllable segments, the user can determine, depending on the position of the sun, the extent of the region which adjoins the upper edge and is to be darkened or provided with high light scattering in order to prevent sun dazzle.

In yet another preferred embodiment, the glazing unit or the laminated pane is a roof panel of a vehicle. The functional element is then preferably arranged in the entire see-through area of the laminated pane. In a typical embodiment, this see-through area comprises the entire laminated pane minus a peripheral edge region which is provided with an opaque cover printing on at least one of the surfaces of the laminated pane. The functional element extends over the entire see-through area, wherein its side edges are arranged in the region of the opaque cover printing and are thus not visible to the observer. The optionally present segments are preferably arranged substantially parallel to a front edge (edge which faces the windshield) of the roof pane with increasing distance therefrom. The user can define by means of the independently controllable segments which regions of the roof pane are to be transparent and which should be darkened or provided with high light scattering, for example depending on the position of the sun, in order to avoid excessive heating of the vehicle interior. It is also possible for each vehicle occupant, i.e., for example, the driver, the front-seat passenger, the passenger in the left-hand back seat and the passenger in the right-hand back seat, to be assigned a respective segment located above them.

The invention is explained in more detail with reference to a drawing and exemplary embodiments. The drawing is a schematic representation and is not true to scale. The drawing does not limit the invention in any way. Shown are:

FIG. 1 a plan view of an embodiment of the glazing unit according to the invention,

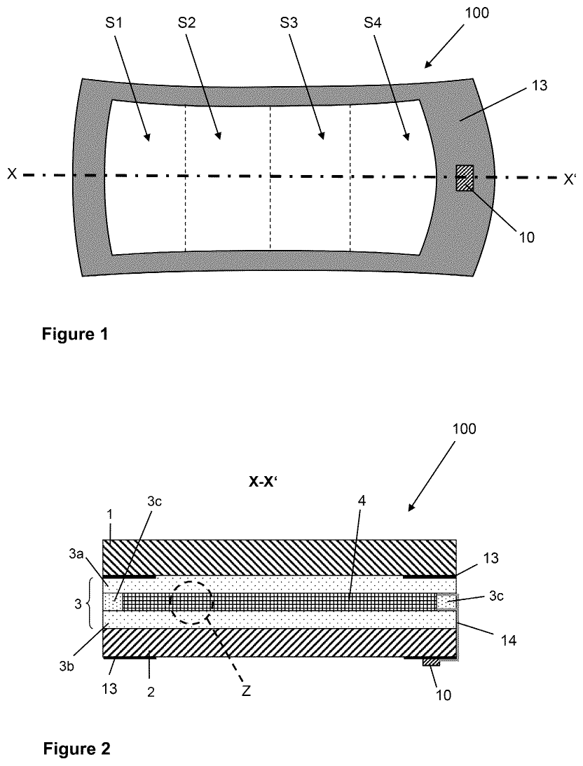

FIG. 2 a cross-section through the glazing unit of FIG. 1,

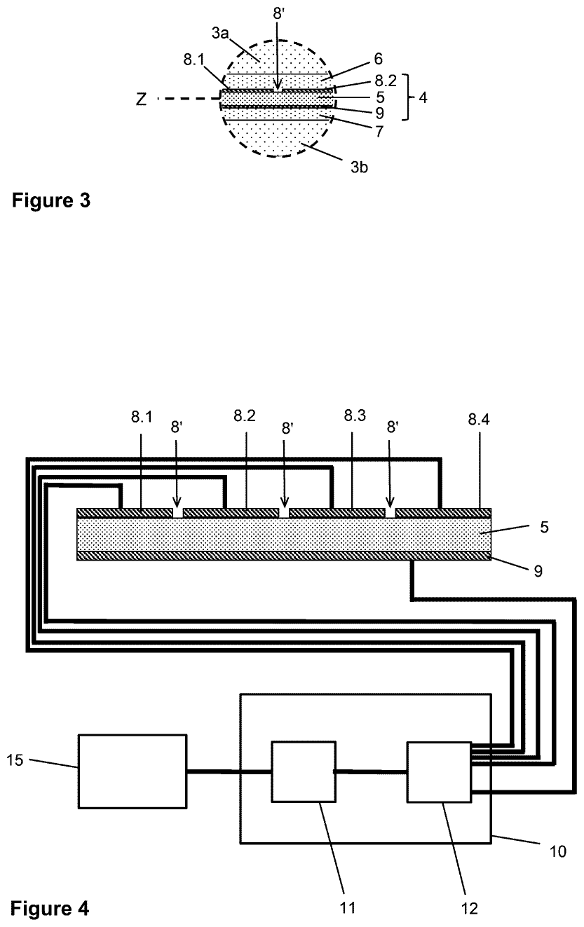

FIG. 3 an enlarged representation of the region Z of FIG. 2,

FIG. 4 the functional element of FIG. 1 in a circuit diagram,

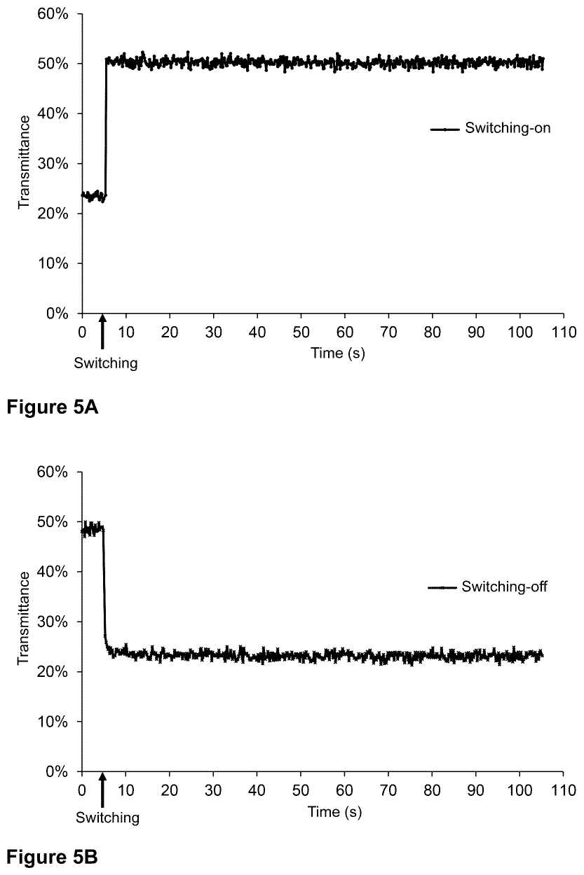

FIG. 5A a diagram of “switching-on” an electrically controllable, generic functional element with the switching time at 23° C.,

FIG. 5B a diagram of “switching-off” an electrically controllable, generic functional element with the switching time at 23° C.,

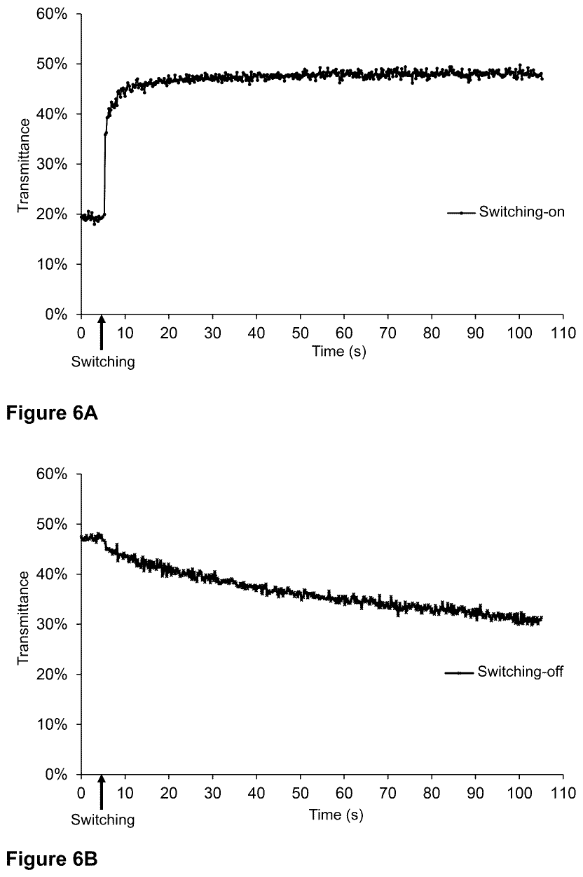

FIG. 6A a diagram of “switching-on” an electrically controllable, generic functional element with the switching time at −20° C., and

FIG. 6B a diagram of “switching-off” an electrically controllable, generic functional element with the switching time at −20° C., and

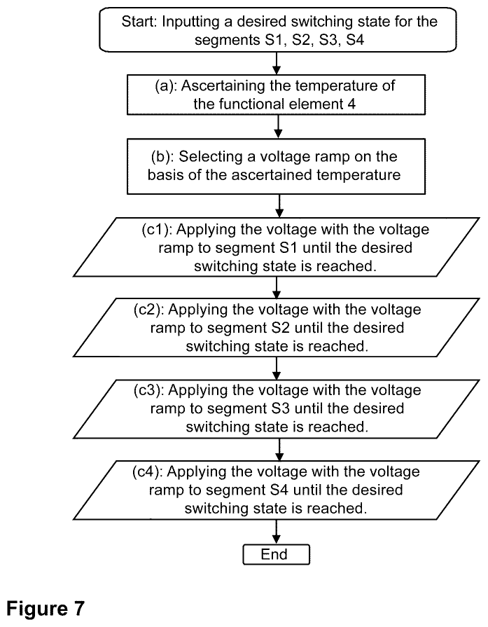

FIG. 7 a representation of the method according to the invention with animation scheme.

FIG. 1, FIG. 2, FIG. 3 and FIG. 4 each show a detail of a laminated pane 100 according to the invention with electrically controllable optical properties. FIG. 1 shows a plan view of the laminated pane 100 according to the invention, whereas FIG. 2 shows a cross-sectional view of the laminated pane, shown in FIG. 1, with the section line X-X′. FIG. 3 shows an enlarged region Z of the cross-sectional view of FIG. 2. The laminated pane 100 is provided, by way of example, as a roof pane of a passenger vehicle, the light transmission of which can be electrically controlled in regions. The laminated pane 100 comprises an outer pane 1 and an inner pane 2, which are connected to one another via an intermediate layer 3. The outer pane 1 and the inner pane 2 consist of soda-lime glass, which can optionally be tinted. The outer pane 1 has, for example, a thickness of 2.1 mm, the inner pane 2 has a thickness of 1.6 mm.

The intermediate layer 3 comprises a total of three thermoplastic layers 3a, 3b, 3c which are each formed by a thermoplastic film having a thickness of 0.38 mm made of PVB. The first thermoplastic layer 3a is connected to the outer pane 1, the second thermoplastic layer 3b is connected to the inner pane 2. The third thermoplastic layer 3c located in between has a cutout in which a functional element 4 with electrically controllable optical properties is inserted essentially in a precise fit, i.e., approximately flush on all sides. The third thermoplastic layer 3c thus forms as it were a kind of mount or frame for the approximately 0.4 mm thick functional element 4, which is thus encapsulated by the thermoplastic material and protected thereby. The functional element 4 is, for example, a PDLC multilayer film which can be switched from an opaque, non-transparent (translucent) switching state of 0% to a clear, transparent switching state of 100%. The functional element 4 is a multilayer film consisting of an active layer 5 between a first planar electrode 8 and a second planar electrode 9 and two carrier films 6, 7. The first carrier film 6 is in planar contact with the first planar electrode 8 and the second carrier film 7 is in planar contact with the second planar electrode 9. The active layer 5 contains a polymer matrix with liquid crystals dispersed therein, which align depending on the electrical voltage (AC voltage) applied to the planar electrodes 8, 9, whereby the optical properties can be controlled. The carrier films 6, 7 are made of PET and have a thickness of, for example, 0.125 mm. The carrier films 6, 7 are provided with a coating made of ITO with a thickness of about 100 nm that faces the active layer 5, and form the planar electrodes 8, 9. The planar electrodes 8, 9 are connected via bus bars (not shown) (formed, for example, from strips of a copper foil) to electrical cables 14, which produce the electrical connection to the control unit 10.

This control unit 10 is attached, for example, to the interior-side surface of the inner pane 2 facing away from the intermediate layer 3. For this purpose, for example, a fastening element (not shown) is glued to the inner pane 2, into which the control unit 10 is inserted. However, the control unit 10 does not necessarily have to be attached directly to the laminated pane 100. Alternatively, it can be attached, for example, to the dashboard or the vehicle body or can be integrated into the on-board electrical system of the vehicle.

The laminated pane 100 has a peripheral edge region which is provided with an opaque cover printing 13. The said cover printing 13 is typically formed from a black enamel. It is imprinted as printing ink with a black pigment and glass frits in a screen printing method and is burned into the pane surface. The cover print 13 is applied, for example, on the interior-side surface of the outer pane 1 and also on the interior-side surface of the inner pane 2. The side edges of the functional element 4 are covered by this cover printing 13. The control unit 10 is arranged in this opaque edge region, i.e., glued onto the cover printing 13 of the inner pane 2. The control unit 10 does not interfere there with the view through the laminated pane 100 and is visually inconspicuous. In addition, it is at a short distance from the side edge of the laminated pane 100 so that only advantageously short cables 14 are necessary in order to electrically connect the functional element 4.

On the other hand, the control unit 10 is connected to the on-board electrical system of the vehicle, which, for the sake of simplicity, is not shown in FIGS. 1 and 2. The control unit 10 is suitable for applying the voltage with the voltage ramp to the planar electrodes 8, 9 of the functional element 4, which is required for the desired optical state of the functional element 4 (switching state), as a function of a control signal which the driver specifies by pushing a button, for example.

The functional element 4 has, by way of example, four independent segments S1, S2, S3, S4 in which the switching state of the functional element 4 can be set independently of one another by the control unit 10. The segments S1, S2, S3, S4 are arranged one behind the other in the direction from the front edge to the rear edge of the roof pane. “Front edge” means the edge of the roof pane that is arranged closest to the front of the vehicle in the installed position, and “rear edge” means the edge that is arranged closest to the rear of the vehicle in the installed position. With the segments S1, S2, S3, S4, the driver of the vehicle can choose (for example, depending on the position of the sun) to provide only one region of the laminated pane 100 instead of said entire laminated pane with the translucent state, while the other regions remain transparent.

In order to form the segments S1, S2, S3, S4, the first planar electrode 8 is interrupted by three isolation lines 8′, which are arranged substantially parallel to one another and extend from a side edge to the opposite side edge of the functional element 4. The isolation lines 8′ are typically introduced into the first planar electrode 8 by laser machining and subdivide the latter into four electrode segments 8.1, 8.2, 8.3 and 8.4 which are materially separated from one another. Each electrode segment 8.1, 8.2, 8.3 and 8.4 is connected to the control unit 10 independently of the others. The control unit 10 is suitable for applying, independently of one another, an electrical voltage between each electrode segment 8.1, 8.2, 8.3 and 8.4 of the first planar electrode 8, on the one hand, and the second planar electrode 9, on the other hand, so that the section of the active layer 5 located between them is subjected to the required voltage in order to reach a desired switching state.

As illustrated in the equivalent circuit diagram of FIG. 4, the control unit 10 is connected to a voltage source 15 via the on-board electrical system of the vehicle. In the vehicle sector, the voltage source 15 typically provides a DC voltage in the range of 12 V to 14 V (on-board voltage of the vehicle). The control unit 10 is equipped with a DC-DC converter 11, which converts the on-board voltage (primary voltage) into a DC voltage of higher magnitude, for example 65 V (secondary voltage). The secondary voltage must be sufficiently high in order to realize a switching state of the functional element 4 of 100%. The control unit 10 is furthermore equipped with an inverter 12 which converts the secondary voltage into an AC voltage. A pole of the inverter 12 is connected to the second planar electrode 9. For the other pole, the inverter 12 has a plurality of independent outputs, wherein each output is in each case connected to an electrode segment 8.1, 8.2, 8.3 and 8.4 so that the switching state of the associated segment S1, S2, S3, S4 can be set independently of the others. In the case of a switching state of 0%, the electrode segments 8.1, 8.2, 8.3, 8.4 and the second planar electrode 9 always have the same electrical potential so that no voltage is applied. In the case of a switching state greater than 0% of a segment S1, S2, S3, S4, a voltage is applied between the associated electrode segment 8.1, 8.2, 8.3, 8.4 and the second planar electrode 9. As a result of the voltage, a current flows through the associated section of the active layer 5.

The switching speed and thus the switching time are temperature-dependent. Lower temperatures from 10° C. in particular result in the functional element 4 or the segments S1, S2, S3, S4 having a lower switching speed for the change between the switching states. At temperatures above 10° C., such a delay is generally not present or is less pronounced. In an arbitrary temperature range, e.g., of −20° C. to 120° C., there is therefore always at least one temperature that results in the longest required switching time tₘₐₓ. In this exemplary embodiment, −20° C. is this temperature. The required switching time to change between two switching states is thus longest when the functional element 4 has a temperature of −20° C.

In addition to the temperature, the switching speed is also defined via a voltage ramp with which the electrical voltage is applied to the segments S1, S2, S3, S4 of the functional element 4. According to the invention, this dependence of the switching speed is utilized in that a voltage with a voltage ramp is applied to the planar electrodes 8, 9, wherein the voltage ramp is selected as a function of the temperature of the functional element 4. For this purpose, a computer program product stored in the control unit 10 instructs the control unit 10 to first ascertain the temperature of the laminated pane 100 or of the functional element 4. The control unit 10 ascertains the temperature and, as a function of the ascertained temperature, the computer program product selects a voltage ramp from a data set stored in the control unit 10 or calculates a voltage ramp by means of a function programmed in the control unit 10 and instructs the control unit 10 to apply an electrical voltage with the selected or calculated voltage ramp to one or more segments S1, S2, S3, S4 of the functional element 4. The electrical voltage is selected such that the desired switching state is reached. Depending on the ascertained temperature, the voltage ramp selected from the data set or calculated by means of the programmed function has a different value or values (linear voltage ramp or non-linear voltage ramp) so that the switching speed at with the switching states are changed is greater or smaller depending on the voltage ramp. The voltage ramp is selected such that the switching time t_{Switch} results for changing the switching states for all ascertained temperatures in the temperature range. The switching time t_{Switch} is, for example, equal to the longest switching time tₘₐₓ which, in this example, is required for a temperature of the functional element 4 at −20° C. In other words, the switching speed V_{Switch} at which the change between the switching states takes place is identical for all temperatures and artificially extended for all temperatures except for −20° C.

However, for some functional elements 4 and temperatures, it maybe the case that the time for increasing and reducing the electrical voltage is of different length. The temperature-dependent time for switching can thus be longer if a switch takes place from a switching state with a higher transparency or higher transmittance to a switching state with a lower transparency or lower transmittance (falling switching state) than if a switch takes place from a switching state with a lower transparency or lower transmittance to a switching state with a higher transparency or higher transmittance (rising switching state). The voltage ramp is therefore, for example, selected or calculated in each case such that, when an electrical voltage is applied to the functional element 4, the switching time t_{Switch} results for both the change to a falling switching state and the change to a rising switching state. In other words, the magnitude of the voltage ramp is different depending on whether a change to a falling or to a rising switching state takes place. This has the result that the switching speed V_{Switch} is the same for both the change to a rising switching state and the change to a falling switching state.

For ascertaining the temperature, the laminated pane 100 can be equipped, for example, with a temperature sensor, which transmits the measured temperature to the control unit 10. A temperature sensor can be dispensed with if the temperature of the functional element 4 is estimated, for example on the basis of the impedance of the active layer 5. An applied voltage results in a current flow through the active layer 5, the extent of which depends on the temperature-dependent electrical impedance. If the current consumption with an applied voltage is ascertained, the current flow or the impedance of the active layer 5 can be ascertained therefrom and can in turn be used to approximately ascertain the temperature. For this purpose, impedance data which link the impedance of the active layer 5 to the temperature are stored in the control unit 10.

FIGS. 5A, 5B, 6A and 6B show diagrams of the transmittance as a function of time for a generic glazing unit. FIG. 5A and FIG. 6A show the change from a switching state with a lower transmittance to a switching state with a higher transmittance (switching-on). FIG. 5B and FIG. 6B show the change from one switching state with a higher transmittance to a switching state with a lower transmittance (switching-off). The transmittance indicates the percentage of light transmission through the laminated pane. The laminated pane or the functional element has a temperature of 23° C. in FIGS. 5A and 5B and a temperature of −20° C. in FIG. 6A and FIG. 6B. The signal to change the switching state occurs for all curves after 5 s (denoted by “switching” in FIGS. 5A, 5B, 6A and 6B). At 23° C., the change to the respectively other switching state (switching-on and switching-off) is completed after less than 1 s. The switching behavior in FIG. 6A and FIG. 6B at −20° C. differs from that at 23° C. The switching-on of the functional element, i.e., the change from a switching state with a transmittance of about 20% to a transmittance of about 47%, requires a switching time of about 5 s. The switching time thus has more than quintupled in comparison to FIG. 5A at 23° C. The effect can be observed even more clearly during switching-off. In this case, the transmittance decreases only by about 25% over a period of 100 s and reaches a transmittance of about 32% within this time. Since measurement was terminated after 105 s, the targeted switching state of 20% is not reached in FIG. 6B.

This temperature-dependent switching behavior with switching times that last from below one second to several minutes will bother a non-specialist user of the glazing unit and may cause the user to make the obvious assumption that the glazing unit is not working properly.

FIG. 7 shows a flowchart for illustrating an exemplary method according to the invention, wherein, after the desired switching state of the functional element 4 with the four segments S1, S2, S3, S4 has been set, the computer program product, for example, instructs the control unit 10 in a first method step to ascertain the temperature of the functional element 4. The desired switching state is, for example, a switching state with a maximum change in the optical properties, i.e., for example, the change from a minimum transparent switching state to a maximum transparent switching state. The temperature is ascertained, for example, by the control unit 10 by means of the temperature-dependent impedance behavior of the functional element 4. In a second method step, a voltage ramp is selected, for example, by means of the computer program product on the basis of the ascertained temperature from the data set stored in the control unit 10. In a third method step, the control unit 10 is instructed by, for example, the computer program product to apply the required voltage with the selected voltage ramp for the purpose of reaching the desired switching state to the first segment S1 of the four segments S1, S2, S3, S4. These three method steps have the result that the switching time for changing the segment S1 to the desired switching state corresponds to the switching time t_{Switch}, or the switching speed for changing from the minimum switching state to the maximum switching state corresponds to the switching speed V_{Switch}. With the expiration of the switching time t_{Switch} for the first segment S1, the desired switching state is reached and a voltage with the selected voltage ramp is applied to the second segment S2 of the four segments S1, S2, S3, S4. With the expiration of the switching time t_{Switch} for the second segment S2, this procedure is repeated with the third segment S3 and subsequently with the fourth segment 4 of the four segments S1, S2, S3, S4. It also applies to the second, the third and the fourth segments S2, S3, S4 that the switching time for changing the respective segment S2, S3, S4 to the desired switching state corresponds to the switching time t_{Switch}. Depending on the functional element 4, the voltage is also maintained after the desired switching state has been reached, or a change takes place to a state in which no voltage is applied by the control unit. In the method shown here for a glazing unit with a PDLC functional element as shown in FIGS. 1 to 4, the voltage is, for example, still being applied to the respective segment S1, S2, S3, S4 after the desired switching state has been reached. In the case of an electrochromic functional element, after the desired switching state has been reached, a change takes place to a state in which no voltage is applied by the control unit, i.e., no external voltage.

In a first embodiment of the method according to the invention, at least the following steps are carried out after the start.

Start: [Inputting a desired switching state for the segments S1, S2, S3, S4] The method is started by selecting the desired switching state for the four segments S1, S2, S3, S4;
(a): [Ascertaining the temperature of the functional element 4] The temperature of the functional element 4 of the glazing unit is ascertained by the control unit 10 after the instruction by the computer program product;
(b): [Selecting a voltage ramp on the basis of the ascertained temperature] A voltage ramp is selected, on the basis of the ascertained temperature from (a), from the data set stored in the control unit 10 or is calculated by means of the programmed function;
(c1): [Applying the voltage with the voltage ramp to segment S1 until the desired switching state is reached.]

An electrical voltage that is necessary for the desired switching state being reached is applied to the first segment S1 of the four segments S1, S2, S3, S4 with the voltage ramp selected in (b). The electrical voltage is also applied further after the desired switching state has been reached, so that the first segment S1 remains in the desired switching state;
(c2): [Applying the voltage with the voltage ramp to segment S2 until the desired switching state is reached.]

After the expiration of the switching time t_{Switch} for the first segment S1, the electrical voltage is applied to the second segment S2 of the four segments S1, S2, S3, S4 with the voltage ramp selected in (b). The electrical voltage is also applied further after the desired switching state has been reached, so that the second segment S2 remains in the desired switching state;
(c3): [Applying the voltage with the voltage ramp to segment S3 until the desired switching state is reached.]

After the expiration of the switching time t_{Switch} for the second segment S2, the electrical voltage is applied to the third segment S3 of the four segments S1, S2, S3, S4 with the voltage ramp selected in (b). The electrical voltage is also applied further after the desired switching state has been reached, so that the third segment S3 remains in the desired switching state;
(c4): [Applying the voltage with the voltage ramp to segment S4 until the desired switching state is reached.]

After the expiration of the switching time t_{Switch} for the third segment S3, the electrical voltage is applied to the fourth segment S4 of the four segments S1, S2, S3, S4 with the voltage ramp selected in (b). The electrical voltage is also applied further after the desired switching state has been reached, so that the fourth segment S4 remains in the desired switching state;
End: The method is completed and is terminated.

The four segments S1, S2, S3, S4 are thus brought successively, from the first segment S1 to the fourth segment S4, into the desired switching state. The desired switching state is reached with the expiration of the switching time t_{Switch}. The order may also be different; for example, the fourth segment S4 could first be brought into the desired switching state, then the third segment S3, then the second segment S2, and finally the first segment S1. Fewer or more segments than the four segments S1, S2, S3, S4 shown here are also possible. The method can thus also be carried out in the same way with a different number of segments. It is also possible for the segments to be switched into different switching states.

### LIST OF REFERENCE SIGNS

S1, S2, S3, S4 Segments of the functional element 4
1 Outer pane
2 Inner pane
3 Thermoplastic intermediate layer
3a First layer of the intermediate layer 3
3b Second layer of the intermediate layer 3
3c Third layer of the intermediate layer 3
4 Functional element
5 Active layer
6 First carrier film
7 Second carrier film
8 First planar electrode
8.1, 8.2, 8.3, 8.4 Electrode segments of the first planar electrode 8
8′ Isolation line between two electrode segments 8.1, 8.2, 8.3,
8.4
9 Second planar electrode
10 Control unit
11 DC-DC converter
12 Inverter
13 Cover printing
14 Electrical cable
15 Voltage source/DC voltage source
100 Laminated pane
X-X Section line
Z Enlarged region

1. A glazing unit with electrically controllable optical properties, comprising:
a laminated pane with a functional element having electrically controllable optical properties, and
a control unit electrically connected to the functional element, wherein the control unit has a data set or a programmed function which assigns a voltage ramp to each temperature in a predefined temperature range, wherein the control unit is suitable for
ascertaining the temperature,
selecting a voltage ramp from the data set on the basis of the ascertained temperature or calculating it by means of the programmed function, and
applying the electrical voltage with the selected or calculated voltage ramp to the functional element.

2. The glazing unit according to claim 1, wherein the functional element comprises at least two switching states with different optical properties and a temperature-dependent switching time is required for the change between the at least two switching states and, consequently, in any arbitrary temperature range there is a temperature with a time tₘₐₓ that corresponds to the longest possible switching time required,
wherein each voltage ramp selected or calculated on the basis of the ascertained temperature results in a switching time t_{Switch} that is longer than or equal to tₘₐₓ, so that the switching time t_{Switch} results when an electrical voltage is applied to the functional element,
wherein arbitrary temperature range means a temperature range that extends over at least 1° C.

3. The glazing unit according to claim 1,
wherein the functional element is divided into at least two separate segments and each segment is electrically connected to the control unit so that the electrical voltage with the selected or calculated voltage ramp can be applied for each segment independently of one another.

4. The glazing unit according to claim 3, wherein the control unit is suitable for applying the electrical voltage first to a first segment of the at least two separate segments and is suitable for applying the electrical voltage to a further segment of the at least two separate segments only after the switching time t_{Switch}.

5. The glazing unit according to claim 2,
wherein the change between two switching states requires a longer time tₘₐₓ at lower temperatures than at higher temperatures.

6. The glazing unit according to claim 1,
wherein the functional element is a PDLC functional element or an SPD functional element.

7. The glazing unit according to claim 1,
wherein the laminated pane has an outer pane and an inner pane, and the functional element is arranged between the outer pane and the inner pane.

8. The glazing unit according to claim 1,
wherein the functional element has an active layer between a first planar electrode and a second planar electrode and the electrically controllable optical properties of the functional element are determined by the active layer.

9. The glazing unit according to claim 8, wherein the first and/or the second planar electrode are formed on the basis of indium tin oxide (ITO).

10. A method comprising controlling a glazing unit with electrically controllable optical properties, in which a glazing unit according to claim 1 is provided, wherein the control unit
(a) ascertains the temperature,
(b) selects a voltage ramp from the data set on the basis of the ascertained temperature or calculates it by means of the programmed function, and
(c) applies an electrical voltage with the selected or calculated voltage ramp to the functional element.

11. The method according to claim 10, wherein the temperature of the functional element is measured with a temperature sensor attached to the laminated pane.

12. The method according to claim 10, wherein an impedance of the functional element is ascertained by means of the control unit, and wherein the temperature of the functional element is calculated by means of the impedance.

13. The method according to claim 12, wherein the control unit is connected to a DC voltage source and is equipped with a DC voltage converter, which converts a primary voltage of the DC voltage source into a higher secondary voltage, and is equipped with an inverter, which converts the secondary voltage into an AC voltage, which is applied to the functional element, and wherein the control unit ascertains the impedance of the functional element from a measurement of the current consumption of the inverter.

14. A non-transitory computer readable medium comprising instructions for performing a method according to claim 10.

15. A method comprising providing a glazing unit according to claim 1 as a window pane of a vehicle.

16. The glazing according to claim 2, wherein the temperature range extends over at least 2° C.

17. The glazing according to claim 16, wherein the temperature range extends over at least 5° C.

18. The glazing unit according to claim 4, wherein the at least two separate segments are changed to the same switching state.

19. The method according to claim 15, wherein the window pane is a side pane, windshield, rear pane or roof pane.
